(19) United States
(12) Patent Application Publication
(10) Pub. No.: US 2023/0159405 A1
(43) Pub. Date: May 25, 2023

(54) SOIL CONDITIONER, BIOFERTILIZER AND BIOPROTECTOR FOR INOCULATING PLANTS

(71) Applicant: ALBO Dunamis, LLC, Wichita Falls, TX (US)

(72) Inventors: Mario Jorge Villaverde, Boca Raton, FL (US); Ana Isabel Fernandez Martinez, Boca Raton, FL (US)

(21) Appl. No.: 17/946,579

(22) Filed: Sep. 16, 2022

Related U.S. Application Data
(60) Provisional application No. 63/244,883, filed on Sep. 16, 2021.

(51) Int. Cl. C05F 11/08; C05G 5/40; C05G 3/40; C05G 3/80; A01N 63/25; A01P 21/00; A01N 63/22; A01N 63/20

(52) U.S. Cl. CPC C05F 11/08; C05G 5/40; C05G 3/40; C05G 3/80; A01N 63/25; A01P 21/00; A01N 63/22; A01N 63/20

(57) ABSTRACT

A bacterial product may comprise strains Azospirillum oryzae AO₅₁₂, Azospirillum lipoferum AL₂₀, Pantoea dispersa PD₂, Bacillus subtilis TU₂, Lysinibacillus sphaericus 3S and Paenibacillus polymyxa SR₁₇, in a total minimal concentration of 10⁸ CFU/g (Colony forming Units). These bacteria may be attached to an insoluble granular carrier formed of a mixture of natural clays and minerals. This formulation may preserve the viability of the microorganism for a long time while in storage, as well as after its application on the field. These microorganisms, as PGPR, may be capable of fixing atmospheric nitrogen, solubilize phosphates, potassium, as well as other minerals immobilized in the soil, which allows for a drastic reduction, and even for a complete elimination, of conventional fertilization methods. These bacteria are not harmful in any sense neither to human beings nor the environment.

### TECHNICAL FIELD

Some aspects of the inventive subject matter are related to an organic product for biofertilization, stimulation of plant growth and resistance to abiotic stress, soil conditioner, as well as for the protection of crops, the biological control of pests and diseases. Some implementations include strains of the genera Azospirillum, Pantoea, Bacillus, Lysinibacillus and Paenibacillus, with the ability to fix atmospheric nitrogen, solubilize phosphates, potassium and other minerals in the soil, as well as to produce siderophores and phytohormones, promote plant growth and rooting, antagonists of phytopathogenic microorganisms, immobilized on solid carrier composed by a mixture of clay and other minerals, which guarantee the nutrition, both of bacteria and crops in its earliest phase. These microorganisms possess a great biofertilizing activity that allows to provide the plants with the necessary nutrients for their development, and pesticide activity for the protection of the plants against different phytopathogenic organisms in general and abiotic stress, while simultaneously promoting the growth and the rooting of different crops. Some aspects also relate to the mode of application in the field, as well as a simple and environmentally friendly procedure for obtaining a product of great stability and effectiveness, applicable to agriculture, gardening and other related activities.

### SUMMARY

In some aspects, a biological biofertilizer, plant growth and rooting enhancer, soil conditioner and bioprotector that is proposed is novel, original and is highly effective for use in commercial agriculture, as well as for use in home plants, gardening and landscaping. In some implementations, it is a natural product including (and in some implementations consisting of) six strains of Plant Growth Promoting Rhizobacteria (PGPR); Azospirillum oryzae AO₅₁₂, Azospirillum lipoferum AL₂₀, Pantoea dispersa PD₂, Bacillus subtilis Tu₂, Lysinibacillus sphaericus 3S and Paenibacillus polymyxa SR₁₇, in a minimal total concentration of 10⁸ CFU/g (Colony forming Units). In some implementations, these bacteria may attached to an insoluble granular carrier formed of a mixture of natural clays and minerals. This formulation may preserve the viability of the microorganism for a long time while in storage, as well as after its application on the field. These microorganisms, as PGPR (Plant Growth Promoting Rhizobacteria), may be capable of fixing atmospheric nitrogen, solubilize phosphates, potassium, as well as other minerals immobilized in the soil, which allows for a drastic reduction, and even for a complete elimination, of conventional fertilization methods. These bacteria are not harmful in any sense neither to human beings nor the environment.

In some aspects, the mechanisms of action of this product are based on the ability of these bacteria to colonize the roots of plants. Once the soil is inoculated by the product, the microorganisms may move to the rhizosphere and colonize the roots of plants and establish their beneficial relationships with them. Then, bacteria may profit from the metabolic activity of plant roots, while providing and facilitating the nutrition nourishment of the plant.

### Summary of Benefits of Some Implementations

a. Biofertilizer, plant growth and rooting enhancer, soil conditioner and bioprotector composed of 100% natural PGPR, which has a high stability, both in storage and during field applications;
b. Its activity may be based on natural processes that are enhanced and stimulated by the product;
c. Significantly reduces conventional fertilization, because the microorganisms which compose it are able to utilize atmospheric nitrogen, solubilize phosphate, potassium and other mineral immobilized in the soil, produce siderophores which chelates iron and supplies it to plants, significantly stimulating the growth of plants and their roots because of its ability to produce plant growth regulators and makes plant nutrient uptake processes and water more efficient due to increased root surface;
d. The biofertilizer enhances the ion-exchange capacity and the water retention of soil;
e. Reduces the nitrates concentration in leafy vegetables and fruits;
f. Significantly reduces the pollution of groundwater and soils;
g. Reduces the emission of greenhouse gases;
h. Reduces soil salinity and improves its structure and porosity;
i. Significantly reduces the work in the field, as the product may be applied once in the short-cycle crops and once a year in perennial crops; and
j. Confers resistance against abiotic stress and protect crops from pests and diseases.

One aspect may be to provide an organic product based on natural mechanisms for stimulation of growth and rooting of plants, at the same time as it facilitates nutrition or plants, while safeguarding against diseases and pests, as well as improving the physical characteristics of soil. The one or more biofertilizers disclosed herein may be composed of a consortium of new strains of Azospirillum oryzae AO₅₁₂, Azospirillum lipoferum AL₂₀, Pantoea dispersa, PD₂ Bacillus subtilis Tu₂, Lysinibacillus sphaericus 3S and Paenibacillus polymyxa SR₁₇, isolated by the inventor(s) from rhizosphere of wild plants. These strains have been formulated and immobilized on a granular solid carrier, composed of a mixture of natural substances that supplies them with necessary nutrients, and provides greater biofertilizing process, improves plant growth and rooting, and enhances biopesticide and soil conditioning activity, while at the same conferring high storage stability and suitability of its application to the field by functioning as a slow-release system of cells and nutrients.

This microbial consortium, in conjunction with the mineral carrier mixture, may give the product a powerful agronomic potential both in the fertilizing and stimulating activity of the growth, through improving rooting, thereby improving health of the plants and the quality of the soils, as well as for its activity in the protection of crops against different pathogenic organisms and abiotic stress in general.

In some implementations, the bacterial consortium may include:
Lysinibacillus sphaericus strain S3, which has a high efficiency in the production of organic acids for the solubilization of phosphates, able to fix of atmospheric N2 and to produce of phytohormones, as well as a high antagonistic activity of phytopathogenic nematodes.
Bacillus subtilis strain Tu₂, which a high efficiency in potassium solubilization, is a strong plant growth and root stimulator, as well as antagonist activity against, phytopathogenic fungi and bacteria.
Pantoea dispersa, PD₂, which is salt-tolerant, has a high capacity to produce organic acids an solubilize phosphate, produces siderophores, and shows antagonist activity against of phytopathogenic nematodes.
Azospirillum oryzae AO₅₁₂, able to fix of atmospheric nitrogen, which has a high capacity to produce phytohormones regulating plant growth and siderophores, as well as the property of growing in insoluble potassium as the sole source of this nutrient.
Azospirillum lipoferum AL₂₀, able to fix of atmospheric nitrogen, which has a high capacity to produce phytohormones that stimulate plant growth and rooting.
Paenibacillus polymyxa SR₁₇, able to fix of atmospheric nitrogen, which has capacity to produce phytohormones regulating plant growth, solubilize phosphate, potassium and other minerals immobilized in the soil, and is a strong antagonistic of phytopathogenic fungi and bacteria.

In some implementations, one or more of these bacteria were obtained from the rhizosphere of wild plants growing in unfavorable environmental conditions. Some implementations may combine these bacterial strains. The joint activity of these microorganisms may give the product an agronomic activity superior to any of the strains individually and to the other mixtures made between the different bacteria tested, because they complement the plant's natural capacity of to supply nutrients needed for proper growth and development.

This consortium or mix of bacteria was formulated with the aim of allowing the product to supply the plants with all major nutritional elements, namely, nitrogen, phosphorus and potassium, as well as preferred microelements. After a selection of strains able to harness atmospheric nitrogen, solubilize phosphates, potassium and other minerals immobilized in soil, the mix of microorganisms was completed taking into account the compatibility between bacteria and their ability to supply the plant with the three major nutrients identified above. The microbial consortium was selected due to its remarkable biofertilizing and bioprotective activity in general, among more than 100 PGPR strains, then combinations between them were tested.

This microbial consortium, in conjunction with the mixture of minerals in the carrier, gives the product a powerful agronomic activity in the fertilizing and stimulating activity of the growth, development of root systems and improvement of plant health and quality of the soils, as well as for its activity in the protection of crops against different pathogenic organisms and abiotic stress in general.

In some implementations, the mix of components used in the solid carrier, including a mixture of natural sources of carbon, phosphorus, potassium, calcium, magnesium and microelements, as well as an ion exchanger. In the product, the most general composition is:

### Product General Composition of Some Implementations

| | |
|---|---|
| N | 0.4-0.6% |
| P | 0.5-0.7% |
| K | 2.5-3.0% |
| Organic matter | 2.0-2.6% |
| Fermentation broths of strains AO512, L20, PD2 | 30-70 mL × kg⁻¹ |
| Fermentation broth strain Tu2 | 20-50 mL × kg⁻¹ |
| Fermentation broth of strain 3S | 20-50 mL × kg⁻¹ |
| Fermentation broths of strain SR₁₇ | 20-50 mL × kg⁻¹ |

### Solid Carrier Components of Some Implementations

1. Clays and minerals (ionic exchangers)—including but not limited to Vermiculite, Perlite, Sepiolite, Zeolites;
2. Nitrogen—Including but not limited to Bone Fish Meal, Blood Meal, Feather Meal, Seaweed extract;
3. Phosphorus—Including but not limited to Phosphate Rock, Bone Fish Meal, Vermicompost, Hydroxyapatite, manure, compost and guano;
4. Potassium—Including but not limited to Green Sand, Feldspar-K, Mica, Kelp Meal, sylvite and sylvanite.
5. Organic Matter—Leonhardite, humic and fulvic acids, humate, humalite, manure and compost.

The carrier components, in which the bacterial consortium and the nutrients have been adsorbed, facilitate their survival and activity both in storage conditions and in the field applications.

In some implementations, the desorption of the cells and the gradual solubilization of the different components of the product and the capacity of ion exchange, all of which conjugate, may confer a slow-release behavior of the cells and nutrients to the environment. This effect may facilitate cell survival and is also a source of nutrients for both, microbial and plant growth in its earliest phase. All these related properties may allow for a drastic reduction or even the elimination of conventional chemical fertilization, as well as a remarkable reduction of field work.

In some implementations, the product contains a total cell concentration higher than 10⁸ CFU×g⁻¹ of carrier and has a survival above 90% in a period of up to two years of storage at room temperature. The mixture may act as a stimulator of growth and development of plant rooting and may act as a biofertilizer, while also retaining its beneficial properties over time.

In some implementations, the product may not generate any waste in its production, since all the intermediate products of the process may be used in the manufacture of the end product, which makes this product production respectful with the environment.

In some implementations, the product is a significant reduction in labor since it is applied only once in short cycle crops and once a year in perennial crops.

Some implementations include a biological product, based on Plant Growth Promoting Rhizobacteria, for stimulating the growth and rooting of plants, while facilitating their nutrition, thus reducing environmental pollution and in turn, improving the physical characteristics of soil. Likewise, it contributes to the health of the crops by preventing and combating pests and diseases, serving as a useful tool for conventional farming, integrated pest management and organic farming.

In some implementations, the microbial strains or mutants thereof, may have combined use in a product with plant growth and rooting stimulating activity, biofertilizer, soil conditioner and biopesticide. The solid carrier in which bacteria are immobilized may warrant their viability and stability for long periods in storage conditions or in field applications. Moreover, it confers a behavior of slow release to product, as well as enhances the ion-exchange capacity and the water retention of soil.

Some implementations provide a product for crops protection of phytopathogenic bacteria, fungi and nematodes. Some implementations provide a biofertilizer product, capable of enhancing natural mechanisms, such as the biological fixation of atmospheric nitrogen and the solubilization of minerals in the soil, to supply plants with the nutrients necessary for their growth and development.

The way and frequency of application of implementations of the product may be used only once in short cycle crops and once per year in perennial crops. This application may be performed using several methods as appropriate, such as but not limited to: mixing the fertilizer with the substrate in seedlings, applying under the seedling on the nursery transplanting hole, and propagation of the fertilizer material in the irrigation dripper located in the planting line or around the plant in rainfed crops.

In some implementations, the manufacture the product, unlike other industrial processes, it does not generate any residue and harmful byproducts, because all the intermediate steps and ingredients used in the manufacturing process, become part of the final product, which greatly simplifies their manufacture and makes this product truly respectful of the environment.

### BRIEF DESCRIPTION OF THE DRAWINGS

FIG. 1 Process flowchart of a method for producing an active composition of the biological fertilizer disclosed in the present invention.

FIGS. 2A-2F show the results of fertilization treatments in plants, obtained with the biological fertilizer described in the present invention.

FIGS. 3A-3G show results obtained in different tests where the biological fertilizer described in this invention was shown to be highly effective in combating known debilitating plant diseases.

FIGS. 4A, 4B are micrographic images of colonization of root surfaces by inoculating bacteria embodied in the present invention.

FIG. 5 is a graph illustrating growth of lettuce.

### DESCRIPTION OF THE SOME EMBODIMENTS

Some embodiments of the inventive subject matter will now be described with reference to the drawings. Identical elements in the various figures are identified with the same reference numerals.

The ability to fix atmospheric nitrogen, solubilize phosphorus and potassium was used to the isolation and selection of the strains, to which, it was used selective culture media for each element in particular Nitrogen (EA Rodriguez Caceres 1981), Potassium (K B Prajapati and H A Modi 2012) and Phosphate (Mehta, S. and C S Nautiyal 2001). Once isolates strains of these three groups, the best ones were chosen in each group according, to their ability to fix N2, solubilize PO₄³⁻ or K and then, a screening was made taking in account the ability to stimulate plant growth. (Fernandez-Martinez A. I. 1996) using the fresh weight of wheat seed roots in vitro as the test model. In order to obtain a microbial consortium capable of supplying the plant with the 3 most important microelements (NPK), mixtures of strains were made, guaranteeing that each consortium include N2 fixers, and solubilizers of PO4 and K. With these mixtures, a solid product was prepared, wetting a previously prepared mineral mixture with the fermentation broths and then drying at a temperature not higher than 110° F. BF2 mixture was the best option, so it was decided to continue with this consortium that is composed of the strains AO₅₁₂, AL₂₀, PD₂, Tu₂, 3S and SR₁₇.

### Description of Some Implementations of the Product

In some implementations, the solid carrier may include a mixture of different raw materials, which basically include sources of nitrogen, phosphate, potassium, organic matter, microelements and an ion exchanger, in sufficient quantities for the product to begin to act and allow the establishment of the cells in the root and guarantee their interaction with the plant, these solids are added in a mixer of solids, until forming a homogeneous mixture. which in the example have the following composition:

### Example of Product Composition

| | | |
|---|---|---|
| Soil conditioner biofertilizer and biopesticide | 1000 | g |
| Fermentation broth strains | 100 | mL |
| Ammonium sulfate (in solution) | 17 | g |
| Dipotassium phosphate (in solution) | 4.5 | g |
| Zinc nitrate tetrahydrate (in solution) | 0.12 | mg |
| Copper (ii) sulfate pentahydrate (in solution) | 0.024 | mg |
| Manganese sulfate monohydrate (in solution) | 0.12 | mg |
| Iron (ii) sulfate heptahydrate (in solution) | 0.024 | g |
| Bone fish meal | 12.5 | g |
| Phosphate rock | 12.5 | g |
| Black earth humate | 30 | g |
| Green sand | 20 | g |
| Zeolite 0.5-1.5 mm | 900 | g |

A description of the method for obtaining the product according some implementations is explained below as an example:

In some implementations, it is a Biofertilizer, plant growth and rooting enhancer, soil conditioner and bioprotector, to be used in both organic and conventional agriculture. In some implementations, it includes (or consists of in some implementations) viable cells of Azospirillum oryzae strain AO₅₁₂, which is capable of fixing atmospheric nitrogen and has a high capacity to produce plant growth-regulating phytohormones, siderophores as well as the capacity of growing in feldspar as the only source of potassium. Azospirillum lipoferum AL₂₀, able to fix of atmospheric nitrogen, which has a high capacity to produce phytohormones that stimulate plant growth and rooting. Pantoea dispersa, PD₂, which is salt-tolerant, has a high capacity to produce organic acids an solubilize phosphate, produces siderophores, and shows antagonist activity against of phytopathogenic nematodes and Lysinibacillus sphaericus strain 3S which is a nitrogen fixing bacteria too and has great efficiency in the production of organic acids for the solubilization of phosphates and other nutrients of the soil, as well as antagonist of plant microbial diseases. Bacillus subtilis strain Tu₂ that presents a good activity as stimulator of the vegetal growth, antagonist of microbial plant diseases, having also a moderate activity as nematicide, and Paenibacillus polymyxa strain SR₁₇ that is able to fix atmospheric nitrogen, produce phytohormones, solubilize phosphates and potassium and have antagonistic activity against phytopathogenic fungi and bacteria. These bacteria isolated by the authors of the rhizosphere of plants that were growing in stressed condition. The preparation protects plants from abiotic stress and phytopathogenic organisms.

These bacteria may be grown in media that are not the subject of the present disclosure, but which contains only natural components. These bacteria may be adsorbed into a solid carrier containing clays and other natural raw materials. The final product may also incorporate mineral salts to facilitate bacterial growth in the soil.

These microorganisms may have been obtained by combining different methods of isolation, in soils of diverse characteristics, and selected from more than 100 different isolates. They have also been characterized as PGPR. The latter may give them a high biofertilizing and plant growth promoting capacity, that makes it possible to reduce or even eliminate the use of conventional fertilization in different crops. This is a universal product that may work very well in all types of crops and in multiple different environments, such as open fields, nurseries, greenhouses, as well as in gardens and golf courses.

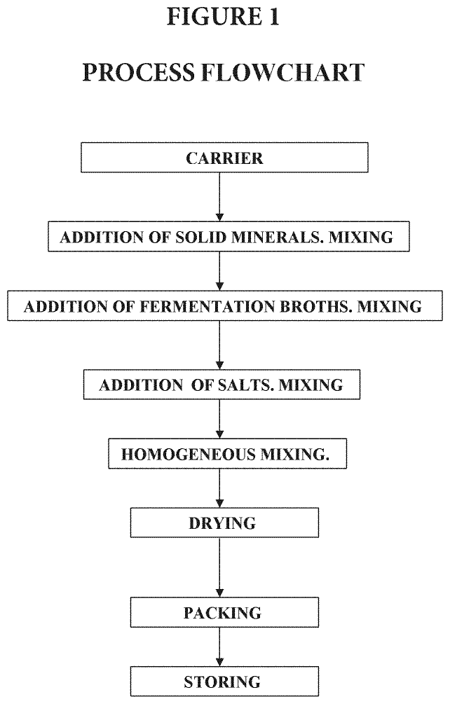

To formulate the product, the different solid components of the composition may be mixed, to homogeneity and impregnated by the different solutions and fermentation broths, then dried at a temperature up to 110° F. to a residual moisture up to 6-8%, as shown in FIG. 1. Shown in FIG. 1 are steps in preparing the biofertilizing product according to some implementations. The process begins with mixing the ingredients, including the six bacteria species with a solid carrier. The components of the solid carrier have been previously listed in the summary section of this disclosure. Once thoroughly mixed in step, the mixture or consortium is thoroughly dried in step, then packed as appropriate or desired in step and stored in step 60 until application or delivery, which is the end of the process.

In one example the product obtained was periodically checked for cell viability in Potato-Tomato Agar solid medium, proving that it maintains more than 90% viability up to two years of conservation at room temperature, not higher than 95° F.

### Examples of Stimulation of Plant Growth

### Example 1

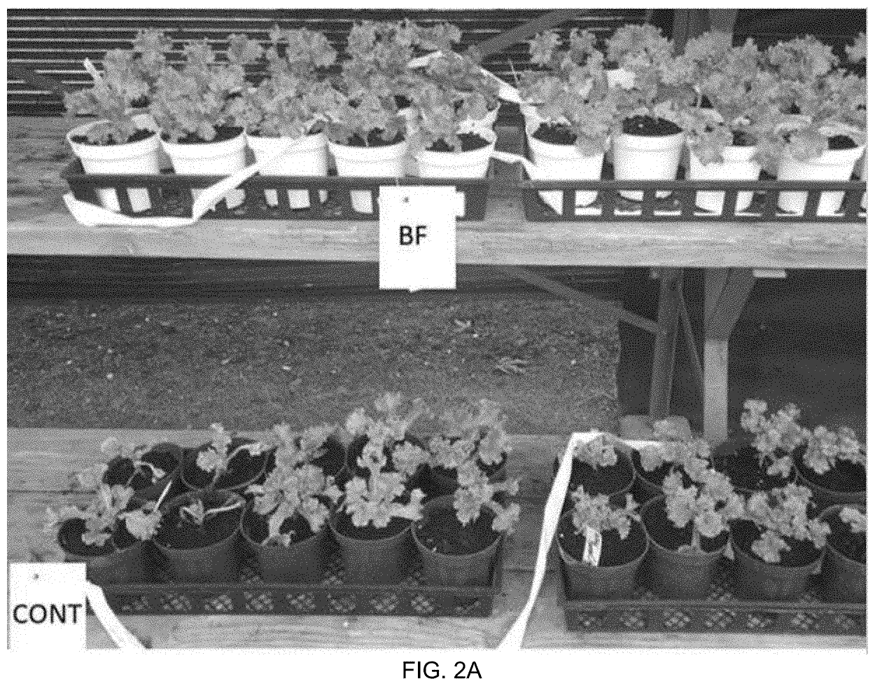

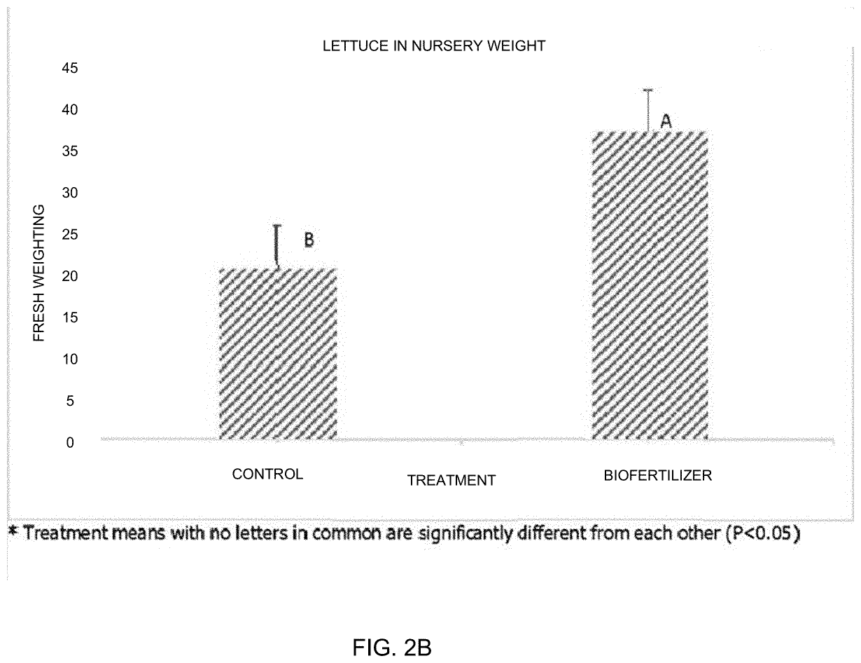

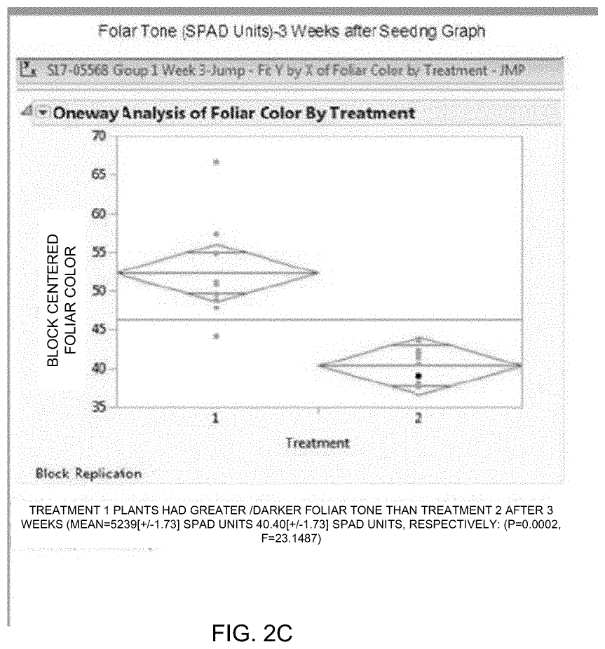

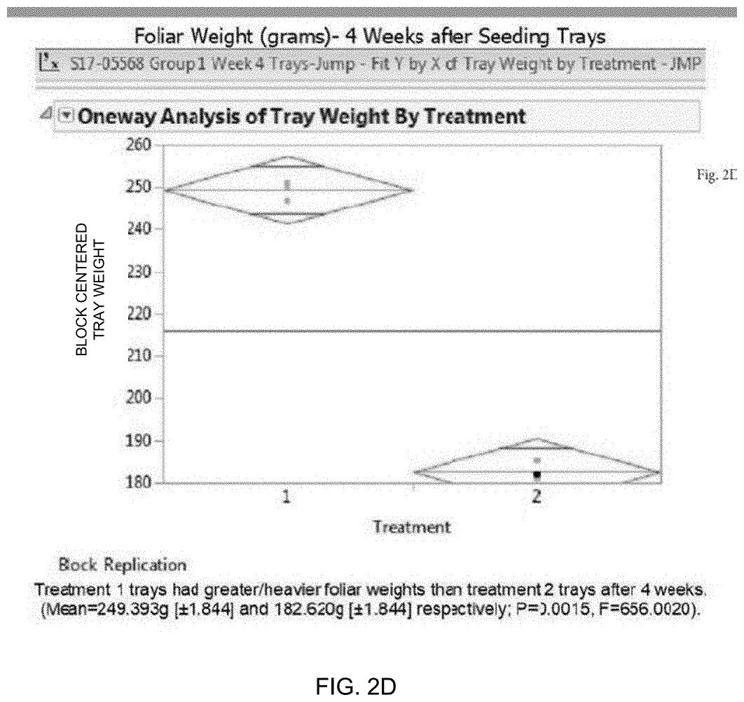

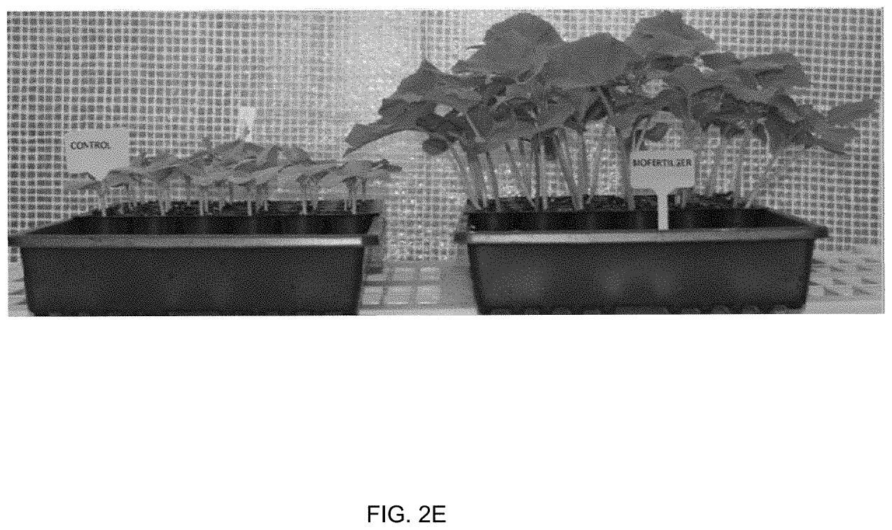

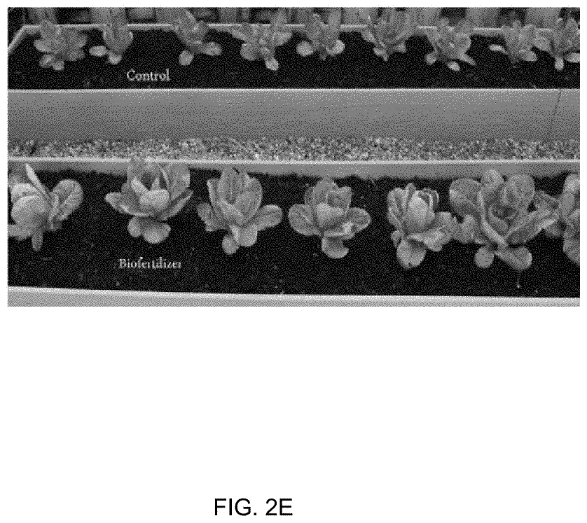

To test the ability of the bioproduct to stimulate plant growth, a greenhouse test was carried out using 300-mL capacity pots, filled with a peat-based substrate plus a common organic fertilizer mixture to function as control specimen. The same substrate as in the control specimen was also used for the treatment specimen using the biofertilization, to which or 50 g/L of the biofertilizer was added. Lettuce seedlings were used, with 20 repetitions per treatment. The plants were irrigated daily with water, throughout the 18 days that the experiment lasted from the moment of the transplant. FIG. 2A, demonstrates this evaluation, which Lettuce seedlings representing a control group before evaluation shown on the lower shelf marked “CONT” and the seedbed treated with the biofertilization, namely, +50 g/L shown on the top shelf. Note that plants consistently demonstrate a more exuberant growth and advance development then the plants in the control group.

Furthermore, it can be observed from the biofertilized group that there is a remarkable stimulation of the fresh weight of the plant in the treatment with the product, which shows that there has been a remarkable acceleration of the vegetative development of the plant in a relatively short period of time, as shown in the photo of both treatments before being evaluated. Obviously, the inoculation with the product has caused a remarkable increase in the growth, in relation to the control that has not been inoculated. An analysis of variance and a mean significance test were carried out on the results of the test, finding significant differences between the treatments that are shown in FIG. 2B.

### Example 2

Treatment 1—BIOFERTILIZER 50 g/L+Miracle-Gro Garden Soil All Purpose (feeds up to 3-M).

Treatment 2 (control)—Miracle-Gro Garden Soil All Purpose (feeds up to 3-M).

Seeds—Cucumber seeds: Organic Ferry-Morse Cucumber Straight Eight

Pots—Square 250 ml pots and corresponding trays.

Planting of Seeds and Germination—Pots were filled with the appropriate media according to treatment, placed on the trays and were sprayed with water using a shower nozzle until saturation. Cucumbers were seeded at the rate of 2 seeds per pot and lightly covered with vermiculite and moss particles. A mist/fog nozzle was used to water-in the seeds. Seeds were planted and placed into a climate-controlled growth chamber. While in the growth chamber, the seeds were watered daily using a mist bottle. Once the seeds began to emerge, they were placed in a Greenhouse. Emerging plants were thinned to one plant per pot, leaving the stronger plant in both the controlled group and biofertilized group.

### Plant Maintenance

While at the greenhouse, plants were monitored daily for any routine maintenance procedures (watering, spacing of trays, rotations of plants, etc.).

### Data Collection

Foliar color measurements were collected on 3 sub-replicate plants per tray. Measurements were taken 3 and 4 weeks after planting. The foliar measurements were only collected from newly matured leaves. A SPAD 502DL Plus Chlorophyll Meter was used to collect the foliar color measurements. Foliar weights were collected on 3 sub-replicate plants per tray, recorded 4 weeks after planting and was obtained by cutting the plants and then weighed using a calibrated balance. Temperature and humidity data was recorded for the germination and growth while confined to a greenhouse.

### Statistical Analysis

Raw data were transferred from this trial to data analysis software. JMP 11® software system was used to determine the means, pooled t, and ANOVA statistical analysis of the data.

### Results and Discussion

Summaries of foliar color tones are presented in Tables 1 and 2 summarize the foliar weights achieved by the control group and the group fortified with the biofertilizer.

TABLE 1
Three weeks after seeding-foliar tones (individual plants)

| | Minimum | Maximum | Mean |
|---|---|---|---|
| Treatment | SPAD units | SPAD units | SPAD units* |
| BIOFERTILIZER + | 44.80 | 68.80 | 52.39A |
| Miracle-Gro Garden Soil All Purpose | | | |
| Miracle Gro-Garden Soil All Purpose | 36.30 | 42.90 | 40.40B |

*Treatment means with no letters in common are significantly different from each other (P < 0.05)
Treatment 1 plants had greater/darker foliar color tone than Treatment 2 plants after 3 weeks with mean of 52.39 SPAD units and 40.40 SPAD units respectively; the difference is statistically significant (P = 0.0002, F = 23.9487). (Table 1)

As presented in FIG. 2C and Table 2, trays comprising the treatment 1 group had significantly greater/heavier foliar weights than trays comprising treatment 2 group. The difference in foliar weights was even more pronounced after four weeks of growth (see FIG. 2D), with a mean of 249.393 g and 182.620 g respectively (P=0.0015, F=656.0020). Based on the results of this study, BIOFERTILIZER provided statistically significant darker foliar color tones at 3 and 4 weeks after seeding. It also achieved statistically heavier foliar weights 4 weeks after seeding.

TABLE 2
Four weeks after seeding-foliar weights trays

| | Minimum | Maximum | Mean |
|---|---|---|---|
| Treatment | (grams) | (grams) | (grams)* |
| BIOFERTILIZER + | 245.94 | 254.26 | 249.39A |
| Miracle Gro Garden Soil All Purpose | | | |
| Miracle Gro Garden Soil All Purpose | 175.62 | 186.29 | 182.62B |

*Treatment means with no letters in common are significantly different from each other (P < 0.05)

Placing these findings in a visual context in FIG. 2E, the treatment 1 group is represented by the tray on the right, while treatment 2 group is represented by the tray on the left. The only difference between the two treatment groups is the presence of the biofertilizer disclosed herein. All other features, such as seed, growing conditions, soil substrate and care were kept constant with these groups. Treatment group 1 has visibly achieved a better and healthier progress than the treatment group 1, the result that must be attributed to the presence of the product disclosed herein.

### Example 3. Cultivation of Lettuce in Soil at Full Cycle

To check the effectiveness of the product as a fertilizer in a complete cycle of a crop, an assay was carried out in which we proceeded to cultivate until maturation plants of lettuce, in separate beds that contained as a substrate, surface layer of soil (topsoil), performing 2 different treatments. Treatment 1-Flowerbed FIG. 2F, row of trays on the right, only had the superficial layer of soil, subjected to a scheme of conventional chemical fertilization for this type of crop. Treatment 2-Flowerbed, row on the left in FIG. 2F, contained the same superficial layer of soil, in which 5 g of product was placed under the hole at the time of the transplant. No fertilization was added to this treatment during the entire trial period.

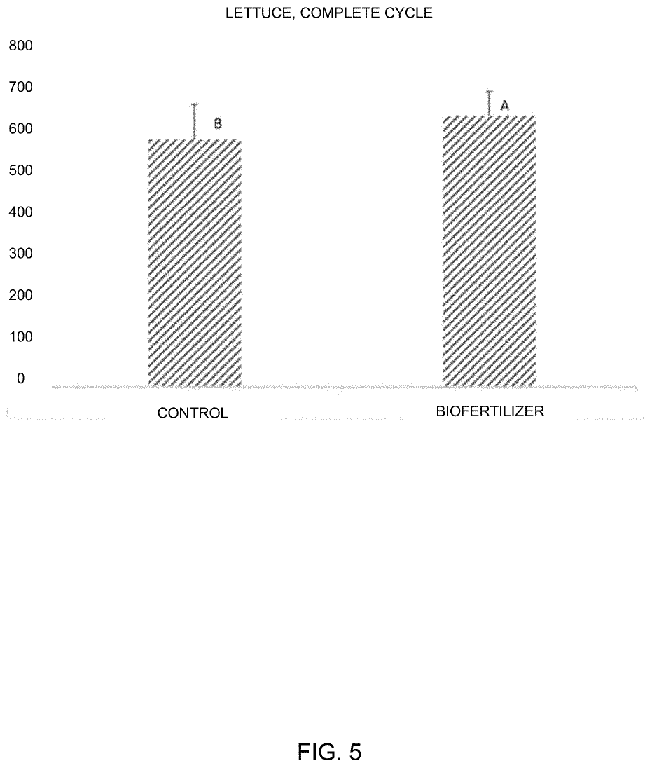

The plants were watered daily and cut 48 days after the transplant. The results are shown in FIG. 5.

FIG. 5 demonstrates that there are significant differences between the statistics mean of both treatments—even if this is small—despite of the fact that control was fertilized periodically and in the other treatment it was only used in the biofertilizer once, at the beginning of the trial. This result demonstrates the ability of this product to completely replace conventional chemical fertilization in some crops.

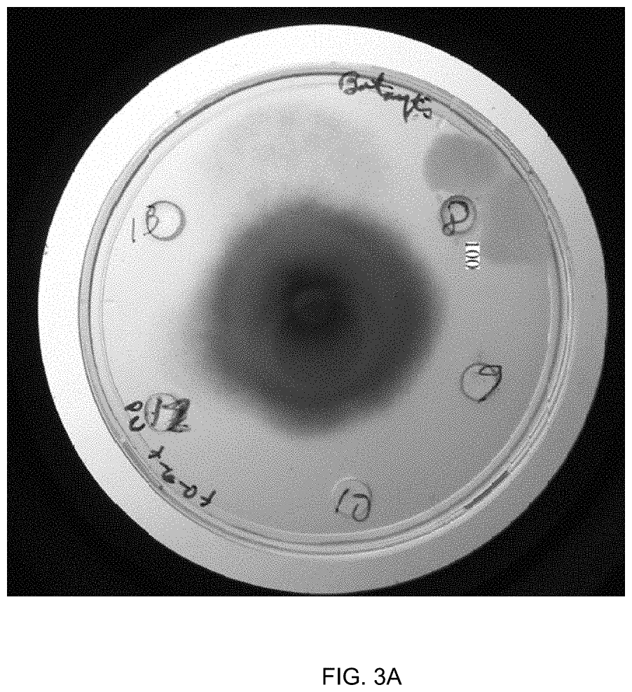

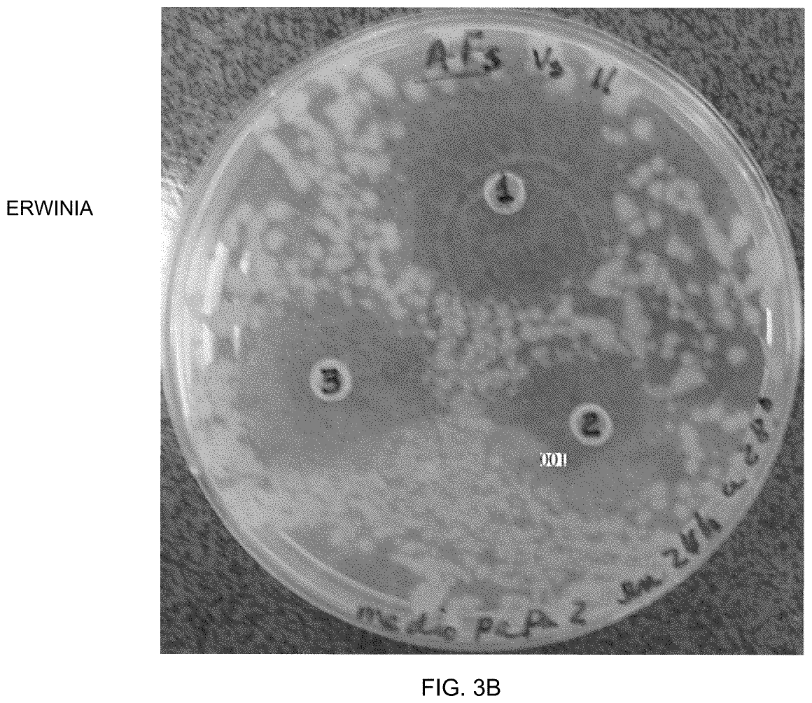

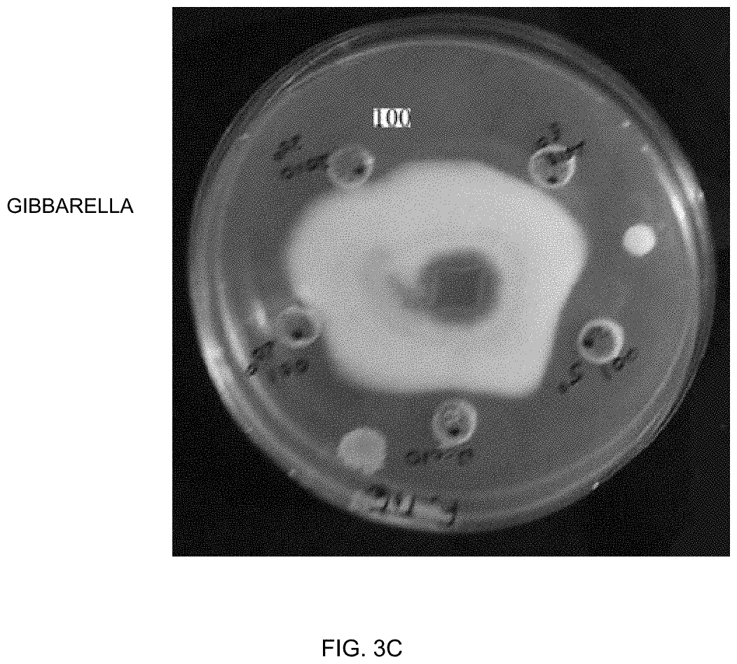

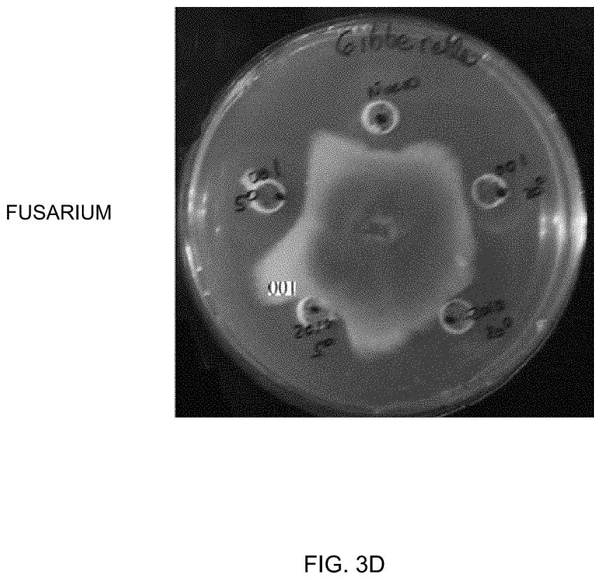

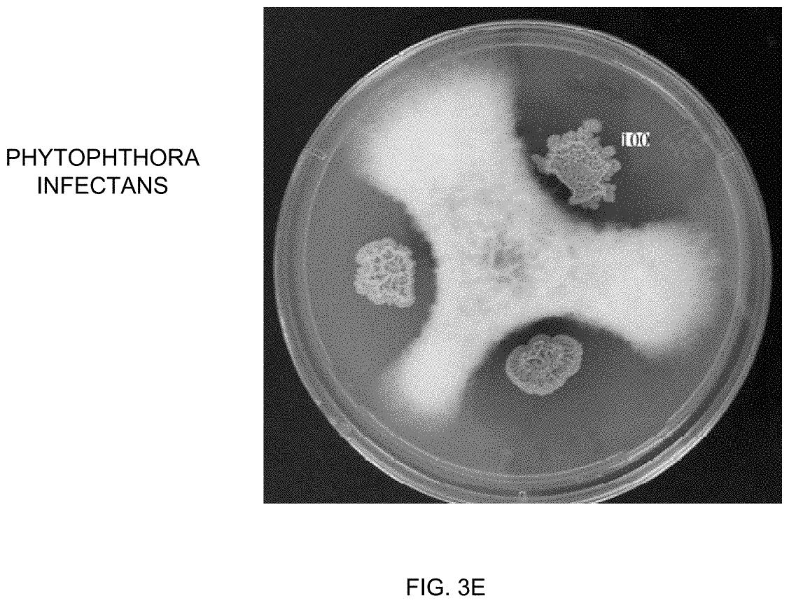

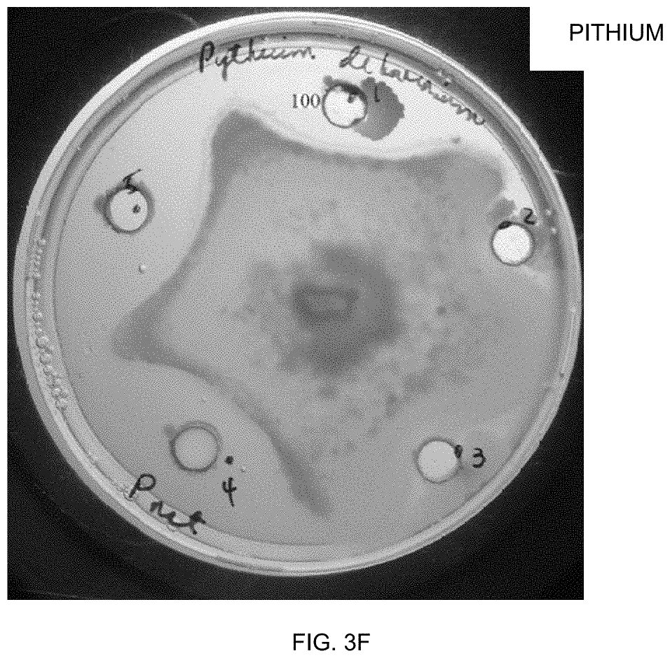

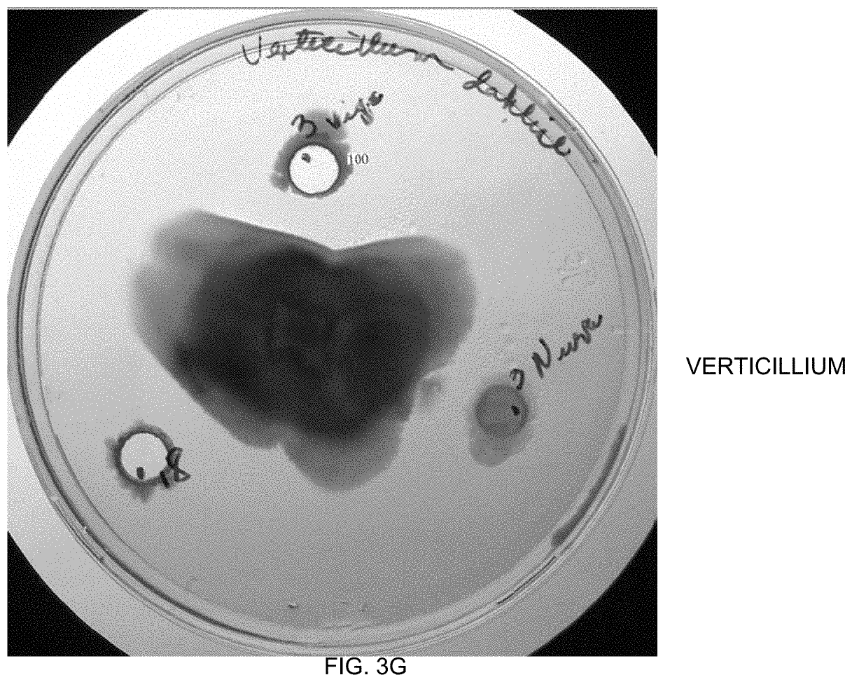

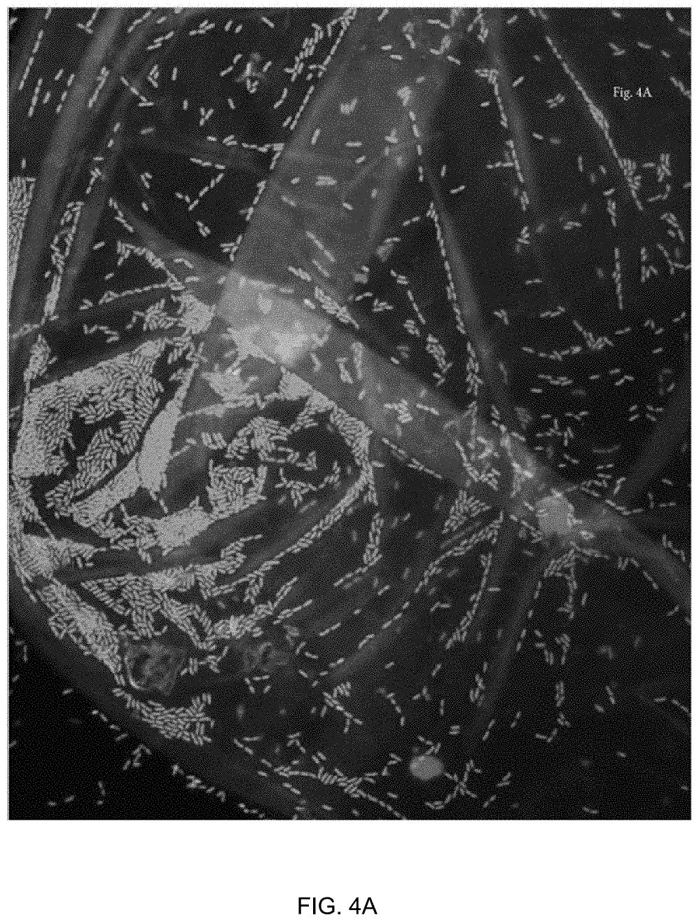

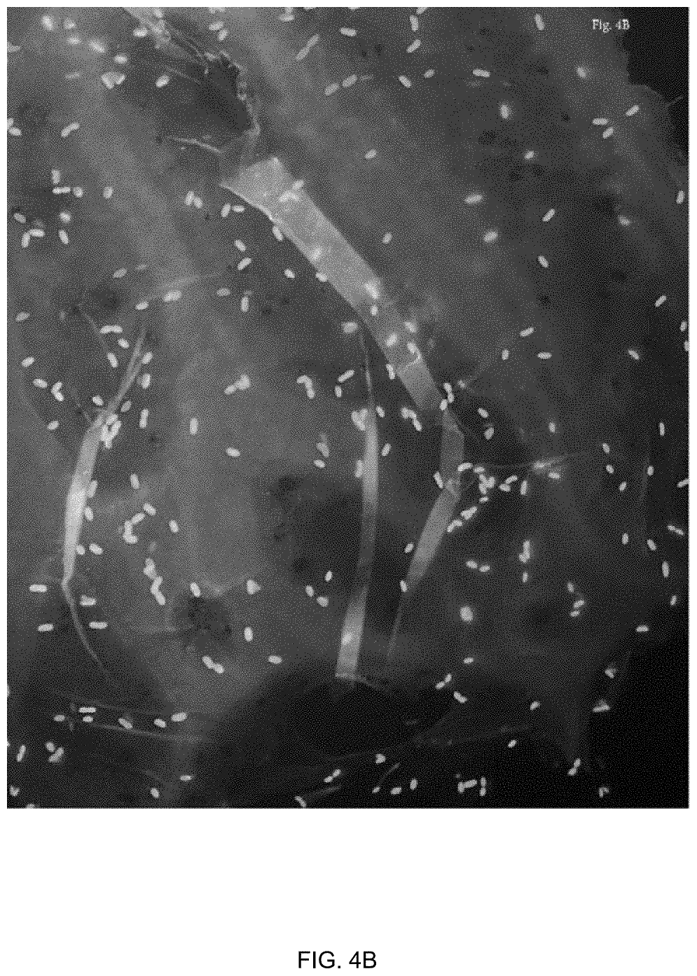

FIGS. 3A-3G demonstrate the petri dishes containing various antagonists or phytopathogenic microorganisms, otherwise known as root and plant parasitic infections and diseases. In each figure, the pathogenic microorganism occupies the center of the petri dish, which is also the area not treated with the biofertilizer, while the indicia 100 indicates areas of the petri dish where an amount of biofertilizer has been deposited. Areas where biofertilizer has been deposited, and in many cases, surrounded areas as well, have been cleared of the pathogen. In practical applications, the biofertilizer, actively combats an existing disease. Additionally, bacteria comprising the biofertilizer is released at a slow pace through dry substrate, thus continuing to then inoculate a plant from the vanquished disease and other diseases. Leading to a more thorough colonization of the pant root system by the friendly bacteria as shown in FIGS. 4A and 4B, including the bacteria comprising the biofertilizer, and better synthesis of atmospheric nitrogen, phosphates, potassium and other minerals naturally found in the soil.

Although some implementations have been described with a certain degree of particularity, it is to be understood that the present disclosure has been made only by way of illustration and that numerous changes in the details of construction and arrangement of parts may be resorted to without departing from the spirit and the scope of the invention.

### Embodiments

This section sets forth some embodiments of the inventive subject matter. However, this is not an exhaustive list of embodiments of the inventive subject matter described in this disclosure.

Embodiment 1—A biological fertilizer and plant growth stimulator comprises:
a. a pure culture of strain AO₅₁₂ of the Azospirillum oryzae
b. a pure culture of strain AL₂₀ of the Azospirillum lipoferum
c. a pure culture of strain PD₂ of the Pantoea dispersa
d. a pure culture of strain TU₂ of the Bacillus subtilis
e. a pure culture of strain S3 of the Lysinibacillus sphaericus
f. a pure culture of strain SR₁₇ of the Paenibacillus polymyxa
   All these strains may be deposited in a Type Culture Collection recognized under Budapest Treaty to meet the requirements on the International Recognition of the Deposit of Microorganisms for the Purposes of Patent Procedure (in USA could be NRRL (Agriculture Research Service od USDA) or ATCC (American Type Culture Collection).
   Embodiment 2—The biological fertilizer of Embodiment 1, wherein said cultures AO₅₁₂, AL₂₀, PD₂, TU₂, S3 and SR₁₇ are immobilized in an insoluble granular carrier.
   Embodiment 3—The biological fertilizer any one or more of Embodiments 1-2, wherein said insoluble granular carrier is selected from the group consisting of clays; Vermiculite, Perlite, Sepiolite, Zeolites, nitrogen; Bone Fish Meal, Blood Meal, Feather Meal, Seaweed extract; phosphorus, Soft Phosphate Rock, Phosphate Rock, Bone Fish Meal, Vermicompost, Hydroxyapatite, manure, compost and guano, potassium; Green Sand, Feldspar-K, Mica, Kelp Meal, sylvite and sylvanite
   Embodiment 4—The biological fertilizer of any one or more of Embodiments 1-3, wherein said cultures are formed from Plant Growth Promoting Rhizobacteria (PGPR).
   Embodiment 5—The biological fertilizer of any one or more of Embodiments 1-4, wherein said fertilizer behaves as a slow-release system for releasing cells and nutrients.
   Embodiment 6—The biological fertilizer of any one or more of Embodiments 1-5, wherein said fertilizer behaves as a plant growth stimulator.
   Embodiment 7—The biological fertilizer of any one or more of Embodiments 1-6, behaves as fixer of atmospheric nitrogen and solubilizer of phosphorus, potassium and other minerals immobilized on the soil.
   Embodiment 8—The biological fertilizer of any one or more of Embodiments 1-7, wherein said fertilizer behaves as a plant growth stimulator and soil conditioner.
   Embodiment 9—The biological fertilizer of any one or more of Embodiments 1-8 wherein said fertilizer is applied once in the short-cycle crops and once a year in perennial crops.
   Embodiment 10—The biological fertilizer of any one or more of Embodiments 1-9 wherein said fertilizer confers resistance against abiotic stress and protect crops from pests and disease
2. The biological fertilizer of Embodiments 1-10 wherein said fertilizer has a high stability, both in storage and during field applications

What is claimed:

1. A biological fertilizer, and plant growth stimulator comprising:
a. a pure culture of strain AO₅₁₂ of the Azospirillum oryzae
b. a pure culture of strain AL₂₀ of the Azospirillum lipoferum
c. a pure culture of strain PD₂ of the Pantoea dispersa
d. a pure culture of strain TU₂ of the Bacillus subtilis
e. a pure culture of strain S3 of the Lysinibacillus sphaericus
f. a pure culture of strain SR₁₇ of the Paenibacillus polymyxa
(All these strains have to be deposited in a Type Culture Collection recognized under Budapest Treaty to meet the requirements on the International Recognition of the Deposit of Microorganisms for the Purposes of Patent Procedure (in USA could be NRRL (Agriculture Research Service od USDA) or ATCC (American Type Culture Collection)

2. The biological fertilizer of claim 1, wherein said cultures AO₅₁₂, AL₂₀, PD₂, TU₂, S3 and SR₁₇ are immobilized in an insoluble granular carrier.

3. The biological fertilizer of claim 2, wherein said insoluble granular carrier is selected from the group consisting of clays; Vermiculite, Perlite, Sepiolite, Zeolites, nitrogen; Bone Fish Meal, Blood Meal, Feather Meal, Seaweed extract; phosphorus, Soft Phosphate Rock, Phosphate Rock, Bone Fish Meal, Vermicompost, Hydroxyapatite, manure, compost and guano, potassium; Green Sand, Feldspar-K, Mica, Kelp Meal, sylvite and sylvanite

4. The biological fertilizer of claim 1, wherein said cultures are formed from Plant Growth Promoting Rhizobacteria (PGPR).

5. The biological fertilizer of claim 1, wherein said fertilizer behaves as a slow-release system for releasing cells and nutrients.

6. The biological fertilizer of claim 1, wherein said fertilizer behaves as a plant growth stimulator.

7. The biological fertilizer of claim 1, behaves as fixer of atmospheric nitrogen and solubilizer of phosphorus, potassium and other minerals immobilized on the soil.

8. The biological fertilizer of claim 1, wherein said fertilizer behaves as a plant growth stimulator and soil conditioner.

9. The biological fertilizer of claim 1 wherein said fertilizer is applied once in the short-cycle crops and once a year in perennial crops; and

10. The biological fertilizer of claim 1 wherein said fertilizer confers resistance against abiotic stress and protect crops from pests and disease

11. The biological fertilizer of claim 1 wherein said fertilizer has a high stability, both in storage and during field applications
